(19) United States
(12) Patent Application Publication
(10) Pub. No.: US 2006/0233133 A1
(43) Pub. Date: Oct. 19, 2006

(54) Mobile terminal and method for searching address and locating a correspondent node in a wlan

(76) Inventors: Bo Liu, Shanghai (CN); Li Sun, Shanghai (CN); Xiaoling Shao, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/536,221

(22) PCT Filed: Nov. 24, 2003
(86) PCT No.: PCT/IB03/05366

§ 371 Date: Nov. 25, 2005

(30) Foreign Application Priority Data
Nov. 28, 2002 (CN) 02154356.9

(51) Int. Cl. H04Q 7/32

(52) U.S. Cl. 370/329; 340/825.52; 455/403

(57) ABSTRACT

A method for addressing and locating WLAN communication node is disclosed in the present invention. The GSM or CDMA, which is characterized in broad coverage, the steadiest performance, and the most mature technology, is employed to confirm the subscribers' IP address. One of the communication parties sends data call to another party through GSM or CDMA and transmits the preset information package including the IP address of the calling party, which is processed by the system, to the other party. Then both parties can accomplish the WLAN interconnection based upon the known IP address in the WLAN. The method can also be applied to all the end-to-end communication system for addressing. The present invention relates to the mobile terminal adopting said method. The method can confirm the address information of the WLAN communication node conveniently, and rapidly, thereby decreasing the cost of communication, eliminating or lowering the dependence on the server of Internet so as to make the subscribers communicate more flexibly and conveniently.

### FIELD OF THE INVENTION

The present invention generally relates to a method for addressing and locating network communication node, and more particularly, to a method for addressing and locating WLAN communication node. Said method can be applied to the multimode mobile terminal such as Personal Digital Assistant (PDA) with plurality of wireless interface. The network operators and service providers can employ the technology to provide their clients with corresponding network application service, such as providing Router service to the public wireless LAN (WLAN). The present invention also relates to a mobile terminal adopting the present method.

### BACKGROUND OF THE INVENTION

Since 1980s, the network technology and wireless communication technology have been developing rapidly, and people's life changes a lot due to them. The combination of wireless communication technology with network technology gives birth to a new technology, i.e. wireless network technology. The most important object of the wireless network is to employ wireless communication technology to provide the subscribers with various network online services. In order to accomplish the object, all sorts of wireless communication technology and technical standards are further developed and constituted, wherein Global System for Mobile Communication (GSM) and WLAN are the focus, and more attention is also paid to Code Division Multiple Access (CDMA).

Similar to the development of Internet, GSM also succeeds greatly in the field of wireless communication. Since the business operation of the first GSM network in the world, within the period of no more than ten years, GSM has become the most important cell phone standard in the world, which covers over 170 countries and increases rapidly. As for the WLAN, generally, it is still limited to be operated in the area with high bandwidth, however, the WLAN will be developed gradually in the WLAN places such as schools, hotels, airports and other populous areas in the near future. And the development of the WLAN can also provide more opportunities to enterprises and science and technology lines.

However, the normal use and operation of any network systems should base on the correct communication node IP (Internet Protocol) address. The obtaining of correct IP address mainly relies on preset server, such as DNS (domain name system) server, one of whose main functions is to confirm the IP address of communication node. However, even if the mobile terminal has WLAN interface, currently, the subscriber lacks knowing the network system information of the WLAN to which it is connected.

FIG. 1 illustrates the schematic view of addressing and locating WLAN communication node in the prior art. Assuming that two mobile terminals communicate based on WLAN, they have to include the following steps: firstly, the relevant information of each mobile terminal will be registered and logged on the specific server; then said server updates the database periodically and sends the relevant information to the subscribers; finally, the subscribers using the mobile terminal can only communicate directly or indirectly based on the received information provided by the server. It will depend strictly on some Internets or WLAN network server and operators, which will add additional service fees.

### SUMMARY OF THE INVENTION

The present invention therefore seeks to provide a method for addressing and locating WLAN communication node. The present invention can determine the address information of the WLAN communication node conveniently and rapidly using the above method, thereby decreasing the cost of communication, eliminating or lowering the dependence on the server of Internet so as to make the subscribers communicate more flexibly and conveniently.

In order to solve the above-mentioned problem, the present invention adopts the following technical schemes:

A method for addressing and locating WLAN communication node, the method is accomplished by means of mobile terminal, said method comprises the following steps:

Entering into wireless communication system, and obtaining the communication subscribers dynamic information provided by wireless communication system, such as each IP address of the communication subscribers;

Transmitting data call to the called party by means of wireless communication system, said data call means transmitting the above-mentioned dynamic information to the mobile terminal of the called party;

Receiving and analyzing said dynamic information.

Said method further comprises the step of linking communication by means of WLAN, or interconnecting by means of wireless communication system directly based on the received dynamic information, that is, the step of pulling through the call, or said method further including the following steps:

presetting the fixed information in the mobile terminal;

transmitting the above-mentioned fixed information to the mobile terminal of the called party via wireless communication system;

receiving and analyzing said fixed information.

Said wireless communication system is GSM or CDMA, or the third generation wireless communication system, including CDMA 2000 system, TD-SCDMA system and WCDMA system. Said dynamic information further includes the IP address of Next hop. Said fixed information includes the subscribers' E-mail address, Reply priority, each mobile terminal's Mobile Station International ISDN Number (MSISDN), International Mobile Subscriber Identity (IMSI) and Medium Access Control (MAC).

A mobile terminal, including a receiving means for receiving the dynamic information provided by the service provider in the wireless communication system, and said dynamic information including the IP address of the communication subscribers; a transmitting means for transmitting data call to the called party via wireless communication system, and said data call means transmitting the above-mentioned dynamic information to the mobile terminal of the called party via wireless communication system operated by service provider so as to make the called party communicate with the calling party based upon said dynamic information; an information processing means for analyzing and processing the received dynamic information, which connecting operatively with said receiving means and transmitting means respectively.

Said dynamic information further comprises the IP address of Next hop. In the first embodiment of the mobile terminal of the present invention, said receiving means comprises GSM communication system receiver and WLAN communication system receiver; said transmitting means comprises GSM communication network system transmitter and WLAN communication system transmitter. In the second embodiment, said receiving means comprises CDMA communication system receiver and WLAN communication system receiver; said transmitting means comprises CDMA communication system transmitter and WLAN communication system transmitter. In the third embodiment, said receiving means comprises the receiver of the third generation communication system, such as CDMA 2000 system, TD-SCDMA system and WCDMA system, and WLAN communication system receiver; said transmitting means comprises the transmitter of the third generation communication system, such as CDMA 2000 system, TD-SCDMA system and WCDMA system, and WLAN communication system transmitter. In the fourth embodiment, said receiving means includes GSM communication system receiver, CDMA communication system receiver and WLAN communication system receiver; said transmitting means includes GSM communication system transmitter, CDMA communication system transmitter and WLAN communication system transmitter; said mobile terminal further includes a switching means connecting operatively with the information processing means and used to switch the communication system automatically according to the instructions of the information processing means. In the fifth embodiment, said receiving means includes GSM communication system receiver, CDMA communication system receiver, the third generation mobile communication system receiver such as CDMA 2000 system, TD-SCDMA system, WCDMA system, and WLAN communication system receiver; said transmitting means includes GSM communication system transmitter, CDMA communication system transmitter, the third generation communication system transmitter such as CDMA 2000 system, TD-SCDMA system, WCDMA system and WLAN communication system transmitter; said mobile terminal further includes a switching means connecting operatively with the information processing means and used to switch the communication system automatically according to the instructions of the information processing means.

The mobile terminal of the present invention further includes a memory means which connects operatively with said information processing means and is used to preset fixed information; said fixed information including the subscribers' E-mail address, Reply priority, each mobile terminal's Mobile Station International ISDN Number (MSISDN), International Mobile Subscriber Identity (IMSI) and Medium Access Control (MAC).

Comparing with the prior arts, the present invention has the following advantages because of adopting the above-mentioned schemes:

The GSM, which is characterized in broad coverage, the steadiest performance, and the most mature technology, or CDMA, which develops rapidly now, is employed in the present invention to determine the subscribers' IP address. Using the rich communication resources such as server, base station, data switch center, etc. of the two systems, the address information of the WLAN communication node can be determined conveniently and rapidly, thereby decreasing the cost of communication, eliminating or lowering the dependence on the server of Internet so as to make the subscribers communicate more flexibly and conveniently.

### BRIEF DESCRIPTION OF THE DRAWING FIGURES

The following will describe in detail the present invention with reference to the accompanying drawing, in drawings:

FIG. 1 illustrates the schematic view of addressing and locating WLAN communication node in the prior art;

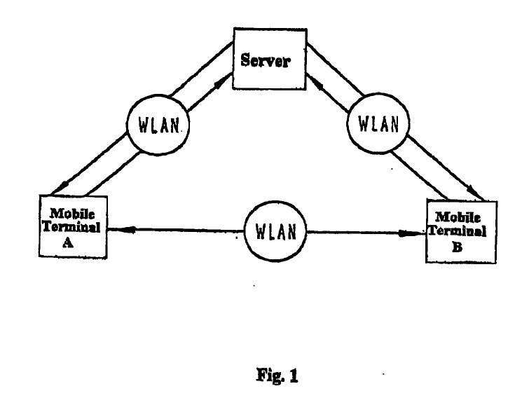

FIG. 2 illustrates the category table of wireless service of the present invention concerned;

FIG. 3 illustrates the flow chart of the method of the present invention for addressing and locating WLAN communication node;

FIG. 4 illustrates the schematic block diagram of the method of the present invention for addressing and locating WLAN communication node using GSM; and

FIG. 5 illustrates the schematic block diagram of the method of the present invention for addressing and locating WLAN communication node using CDMA.

### DETAILED DESCRIPTION OF THE INVENTION

As for any equivalent services, for example, voice dialogue, the main problem lies in the confirmation of the address of communication node, which is easy to do in the GSM, however not easy in the WLAN. In the GSM system, the addressing and locating rely mainly on the database of Visitor Location Register (VLR) and Home Location Register (HLR) in the Mobile Switching Center (MSC).

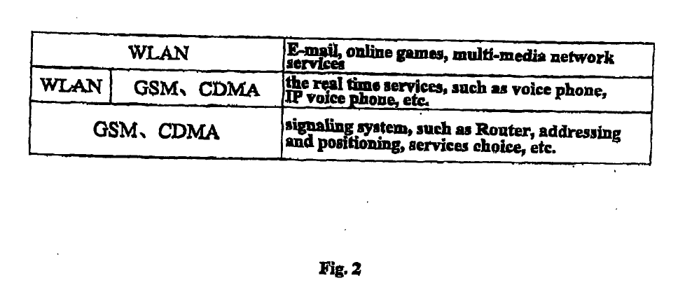

As shown in FIG. 2, since the WLAN has higher bandwidth, it can provide the subscribers with such convenient and rapid interconnecting data communication services, such as e-mail, online games, multi-media surfing, etc. With the broadest coverage area and the most mature technology, the GSM, mainly as the signaling system, runs signal transmission services such as calling Router, addressing and locating, and service choice, etc. As for the real time communication service, such as voice communication, IP voice communication, etc., both WLAN and GSM can be applied.

Therefore, based on the features of different coverage area and bandwidth, the amalgamation of GSM and WLAN can complement each other. At present, multi-service subscriber terminal with plurality of wireless interface has been available on the market. The present invention is based on said subscriber terminal.

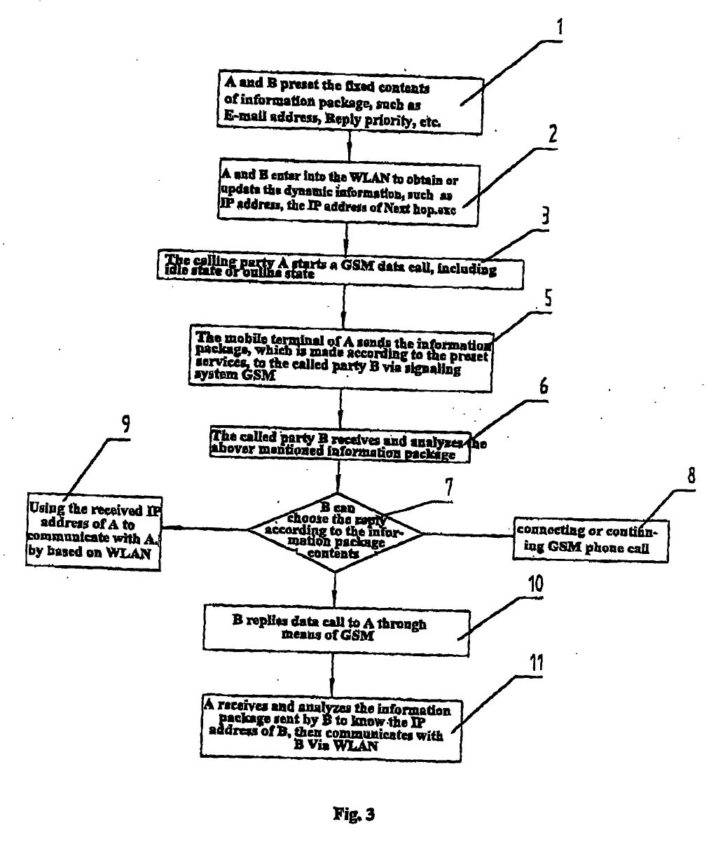

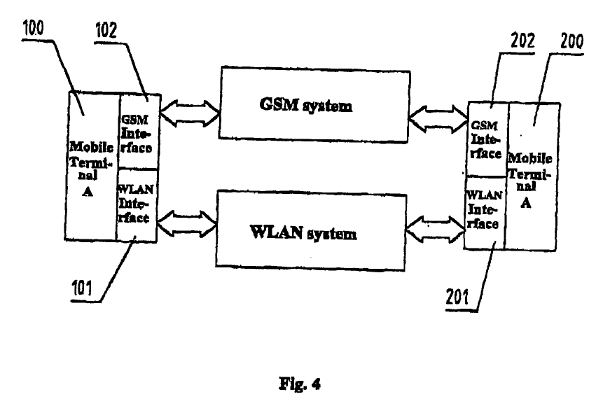

As shown in FIG. 3 and FIG. 4, assuming that the communicating parties are A and B, their mobile terminal A100 and B200 with plurality of wireless interface, include GSM interface 102, 202 and WLAN interface 101, 201. The wireless interface includes receiver and transmitter of wireless communication system, and the mobile terminal further includes an information processing means connecting operatively with the wireless interface and analyzing and processing the received information.

A and B preset the fixed contents of information package when in data call based upon the GSM, such as E-mail address, Reply priority, etc. (Step 1), and the fixed contents may further include each mobile terminal's Mobile Station International ISDN Number (MSISDN), International Mobile Subscriber Identity (IMSI) and Medium Access Control (MAC). At the time, the two mobile terminals are in turn-on connection, registration, and obtaining or updating the dynamic information from the WLAN, such as IP address, the IP address of Next hop, etc. (Step 2). If A wants to communicate with B, men A will send a GSM data call (Step 3). No matter the mobile terminal of A is in idle state or online state, it can start the data call based on GSM. At the time, according to the preset fixed contents and the dynamic information obtained or updated from the WLAN, for example, the set information package includes the IP address of the calling subscriber, Mobile Station International ISDN Number (MSISDN), International Mobile Subscriber Identity (IMSI) and Medium Access Control (MAC), IP address of Next hop, E-mail address and Reply priority, etc., the mobile terminal of A sends the information package contained the above information to the mobile terminal of B via signaling system GSM (Step 5). The mobile terminal of B will display the received information package contents, which is similar to the phone number display when a phone call is available. And the information package contents will be analyzed by means of the mobile terminal of B (Step 6). At the time, B can choose the reply mode according to the information package contents (Step 7), using the received IP address of A, and determine whether the party B communicate with A by means of WLAN directly (Step 9), or connecting by means of GSM directly, i.e. connecting or continuing to the call (Step 8), or replying data call to A by means of GSM (Step 10), then A receives and analyzes the information package sent by B by means of GSM to obtain the IP address of B, and communicates with B through WLAN (Step 11).

If the mobile terminal of B cannot be used on WLAN, then B can only receive the call. If the mobile terminal of B locates not only in the coverage area of GSM, but also in the hot spot area of WLAN, he can choose to communicate with A by means of WLAN or GSM directly taking consideration of the economy, convenience and his personal like.

No matter the mobile terminal of A is in idle state, or in online state linked with B, the data call based on GSM can be started. After receiving and analyzing the IP address of A, B can switch the GSM conversation being using to WLAN communication; or when B needs to leave the hot area or has other needs, B can switch the WLAN communication to GSM conversation according to the other information in the information package.

The above-mentioned information package can choose all the information of the subscriber's IP address, Mobile Station International ISDN Number (MSISDN), International Mobile Subscriber Identity (IMSI), Medium Access Control (MAC), IP address of Next hop, E-mail address and Reply priority, etc., and also is combination of partial contents of the above-mentioned information, but it must include the subscriber's IP address, for example, the subscriber's IP address, Mobile Station International ISDN Number (MSISDN), Medium Access Control (MAC), etc. can be set in the information package.

Wherein, Mobile Station International ISDN Number is the telephone number, which can be used to call the other party; though it involves personal privacy, International Mobile Subscriber Identity can also be used as security authentication, i.e. authentication; the IP address of Next hop obtained can be used to pass the fire wall or the enterprise's intranet and to analyze the address; the Medium Access Control (MAC) can be used as the security authentication of subscriber identity; and E-mail address can be used as the approach of letters swap.

The mobile terminal used by the subscribers should have some functions, wherein, it should be able to classify the called phone into four categories: the first is only used on GSM phones, the second emergency phone calls, such as 110, 119 and 120, etc., the third calling the fixed telephones, the fourth used on WLAN and GSM phones. As for the first three phones, the subscriber calling is the same as the current mobile communication terminal calling, after transferring the call via GSM base station and switching the call via mobile switch center, they are connected with the communication terminal of the called party. While the subscriber is calling the fourth phone, said mobile terminal can automatically send data call request at the same time, then send the information package, in which the information on the calling party has been preset, to the called party. Said information package should at least include the IP address of the calling party so that the called party can choose WLAN or GSM to connect with the calling party flexibly. Generally, the subscribers can make relevant choice according to the area that it belonging to. If the subscribers locate at the hot area of WLAN, such as schools, hotels, airports and other populous places, and the calling party needs the called party to adopt WLAN to connect with him taking consideration of the communication fees and information contents, the called party can know the IP address of the calling party and some detailed information according to the analyzed information package sent by the signaling system GSM, then communicates with the calling party based on WLAN.

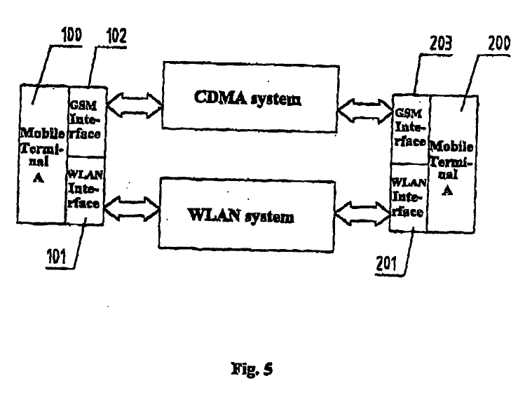

As shown in FIG. 5, the method of the present invention for addressing and locating WLAN communication node can also address and confirm the IP address of communication node by means of CDMA as signaling system. In the second embodiment of the mobile terminal of the present invention, the mobile terminals of the communication parties should have CDMA wireless interface, which includes receiver and transmitter of wireless communication system. Wherein, when the calling party calls the other party by means of CDMA system, the CDMA system is requested a data call automatically, then information package, in which the information on the calling party has been preset, is transmitted to the called party. After receiving and analyzing the relevant information package, the called party can choose WLAN or CDMA to connect with the calling party flexibly.

Similarly, the method of the present invention for addressing and locating WLAN communication node can also address and confirm the IP address of communication node by means of the third generation communication system as signaling system, such as CDMA2000, TD-SCDMA, WCDMA, etc. In the third embodiment of the mobile terminal of the present invention, the mobile terminals of the communication parties should have the wireless interface of the third generation communication system, which includes receiver and transmitter of wireless communication system. Wherein, when the calling party calls the other party by means of the third generation communication system, said system is requested a data call automatically, then information package, in which the information on the calling party has been preset, is sent to the called party. After receiving and analyzing the relevant information package; the called party can choose WLAN or the third generation communication system to connect with the calling party flexibly.

In addition, according to the fourth embodiment of the mobile terminal of the present invention, the mobile terminal with plurality of wireless communication interface including WLAN interface, GSM interface and CDMA interface, etc. can be adopted. And said mobile terminal further includes a switching means connecting operatively with the information processing means and is used to switch the communication system automatically according to the instructions of the information processing means.

Said mobile terminal can be set respectively to use on the phone between WLAN and CDMA, and the phone between WLAN and GSM. When A is calling B via GSM, A sends automatically a request of data call to GSM, then sends the information package, in which the information about the calling party has been preset, to the called party. The information package should at least include the IP address of A. When the above-mentioned system cannot connect with the called party B, the mobile terminal can switch to CDMA system so as to call B automatically, then sends a request of data call to CDMA system, then sends the information package, in which the information about the calling party has been preset, to the called party. The information package should at least include the IP address of A. Alternatively, the calling can be firstly via GSM, then adopt CDMA.

According to the fifth embodiment of the mobile terminal of the present invention, the mobile terminal with WLAN interface, GSM interface, CDMA interface, and the wireless interface of the third generation communication system can be adopted. Said wireless interface includes receiver and transmitter of wireless communication system. And said mobile terminal further includes a switching means connecting operatively with the information processing means and is used to switch the communication system automatically according to the instructions of the information processing means.

The method of the present invention concerned also applies to all the addressing of end-to-end application. The involved IP protocol applies to IPV4 and IPV6. The communication system concerned should include any mature and developing and future communication systems

While specific embodiments of the present invention have been shown and described, it will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for addressing and locating WLAN communication node, whose steps are accomplished by means of mobile terminal, characterized in that said method includes the following steps:
entering into wireless communication system, and obtaining the communication subscribers dynamic information provided by wireless communication system, such as each IP address of the communication subscribers;
transmitting data call to the called party through wireless communication system, said data call transmits the said dynamic information to the mobile terminal of the called party so as to make the called party communicate based upon said dynamic information;
receiving and analyzing the information which is transmitted by the mobile terminal of the calling party.

2. The method for addressing and locating WLAN communication node according to claim 1, further comprising the following step:
making communication through WLAN link according to the received dynamic information.

3. The method for addressing and locating WLAN communication node according to claim 1, further comprising the following step:
interconnecting through wireless communication system directly, that is, pulling through the telephone.

4. The method for addressing and locating WLAN communication node according to claim 1, further comprising the following steps:
presetting the fixed information in the mobile terminal;
transmitting the said fixed information to the mobile terminal of the called party via wireless communication system;
receiving and analyzing said fixed information.

5. The method for addressing and locating WLAN communication node according to claim 1, wherein said wireless communication system is GSM system.

6. The method for addressing and locating WLAN communication node according to claim 1, wherein said wireless communication system is CDMA system.

7. The method for addressing and locating WLAN communication node according to claim 1, wherein said wireless communication system is the third generation wireless communication system, including CDMA2000 system, TD-SCDMA system and WCDMA system.

8. The method for addressing and locating WLAN communication node according to claim 1, wherein said dynamic information further includes the IP address of Next hop.

9. The method for addressing and locating WLAN communication node according to claim 1, wherein said fixed information includes the subscribers' E-mail address, reply priority, each mobile terminal's Mobile Station International ISDN Number (MSISDN), International Mobile Subscriber Identity (IMSI) and Medium Access Control (MAC).

10. A mobile terminal, including:
a receiving means for receiving the dynamic information provided by the service provider in the wireless communication system, and said dynamic information including the IP address of the communication subscribers;
a transmitting means for transmitting data call to the called party via wireless communication system, and said data call uses to transmit the said dynamic information to the mobile terminal of the called party via wireless communication system operated by service provider, so as to make the called party interconnect and communicate with the calling party based upon said dynamic information;
an information processing for connecting operatively with said receiving means and transmitting means respectively, and analyzing and processing the received information.

11. The mobile terminal according to claim 10, wherein said dynamic information further comprising the IP address of Next hop.

12. The mobile terminal according to claim 10, wherein said receiving means comprising GSM communication system receiver and WLAN communication system receiver.

13. The mobile terminal according to claim 10, wherein said transmitting means comprising GSM communication network system transmitter and WLAN communication system transmitter.

14. The mobile terminal according to claim 10, wherein said receiving means comprising CDMA communication system receiver and WLAN communication system receiver.

15. The mobile terminal according to claim 10, wherein said transmitting means comprising CDMA communication system transmitter and WLAN communication system transmitter.

16. The mobile terminal according to claim 10, wherein said receiving means including the receiver of the third generation communication system, such as CDMA 2000 system, TD-SCDMA system and WCDMA system, and WLAN communication system receiver.

17. The mobile terminal according to claim 10, wherein said transmitting means including the transmitter of the third generation communication system, such as CDMA 2000 system, TD-SCDMA system and WCDMA system, and WLAN communication system transmitter.

18. The mobile terminal according to claim 10, wherein said mobile terminal further comprising a memory means which connects operatively with said information processing means and is used to preset fixed information.

19. The mobile terminal according to claim 11, wherein said fixed information including the subscribers' E-mail address, Reply priority, each mobile terminal's Mobile Station International ISDN Number (MSISDN), International Mobile Subscriber Identity (IMSI) and Medium Access Control (MAC).

20. The mobile terminal according to claim 10, wherein said receiving means including GSM communication system receiver, CDMA communication system receiver and WLAN communication system receiver; said transmitting means including GSM communication system transmitter, CDMA communication system transmitter and WLAN communication system transmitter; said mobile terminal further including a switching means connecting operatively with the information processing means and used to switch the communication system automatically according to the instructions of the information processing means.

21. The mobile terminal according to claim 10, wherein said receiving means including GSM communication system receiver, CDMA communication system receiver, the third generation communication system receiver such as CDMA 2000 system, TD-SCDMA system, WCDMA system, and WLAN communication system receiver; said transmitting means including GSM communication system transmitter, CDMA communication system transmitter, the third generation communication system transmitter such as CDMA 2000 system, TD-SCDMA system, WCDMA system and WLAN communication system transmitter; said mobile terminal further including a switching means connecting operatively with the information processing means and used to switch the communication system automatically according to the instructions of the information processing means.
